(19) United States
(12) Patent Application Publication
(10) Pub. No.: US 2016/0141058 A1
(43) Pub. Date: May 19, 2016

(54) APPARATUS AND METHOD FOR REMOVAL OF NUCLIDES FROM HIGH LEVEL LIQUID WASTES

(71) Applicant: AVANTech, Inc., Columbia, SC (US)

(72) Inventors: Tracy A. Barker, Columbia, SC (US); James L. Braun, Irmo, SC (US); Gary A. Benda, Chapin, SC (US)

(21) Appl. No.: 14/940,960

(22) Filed: Nov. 13, 2015

Related U.S. Application Data
(60) Provisional application No. 62/079,368, filed on Nov. 13, 2014.

(51) Int. Cl. G21F 9/12; B01D 15/24; B01D 15/18; B01D 15/36; B01D 15/42

(52) U.S. Cl. CPC G21F 9/12; B01D 15/361; B01D 15/424; B01D 15/1871; B01D 15/24

(57) ABSTRACT

A method for treating a liquid waste is provided. The method includes supplying the liquid waste to a plurality of cross flow filters from at least one high level waste tank; filtering the liquid waste via the plurality of cross flow filters to form a clarified salt solution; removing at least one radionuclide from the clarified salt solution via a plurality of elutable ion exchange columns filled with an ion exchange media to form an eluate and a decontaminated salt solution; and removing at least one radionuclide from the eluate via a first non-elutable adsorption component to form a dewatered radionuclide sorbent and a decontaminated eluate solution.

### PRIORITY CLAIM

This application is based upon and claims priority to provisional application Ser. No. 62/079,368, filed Nov. 13, 2014. The foregoing application is incorporated fully herein by reference for all purposes.

### FIELD OF THE INVENTION

Embodiments of the present invention relate generally to methods and systems for treating liquid wastes having high levels of radionuclides. More specifically, embodiments of the present invention relate to methods and systems for treating liquid wastes having high levels of cesium.

### BACKGROUND

As is well known, nuclear fuel produced in government facilities is processed to remove special nuclear material (SNM) such as plutonium, enriched uranium and other radionuclides of interest. SNM is recovered by dissolving the fuel in acid followed by elemental and isotopic separation of the SNM into separate streams for re-use in nuclear fuel and thermo-nuclear devices. The spent processing wastes remaining after SNM recovery contains fission products, such as strontium-90 and cesium-137, and other radionuclides, primarily lanthanides and actinides, in concentrations sufficient to generate measurable amounts of heat and be labeled as high-level nuclear waste by the US Nuclear Regulatory Commission (US-NRC). The primary non-radioactive constituents of high-level waste are sodium, potassium, aluminum, nitrates, nitrites and sulfates. Most of the high-level waste in the United States was generated by the

Department of Energy (DOE) at the Hanford, Savannah River and Idaho National Laboratory sites. The high-level waste typically exists inside large storage tanks in three physico-chemical phases known as supernate, salt cake and sludge. The Hanford Site has over 53 million gallons of high-level and chemical waste that is now being stored in approximately 170 underground tanks. The Savannah River Site has over 36 million gallons of high level-waste stored in approximately 50 underground tanks. Over the years the DOE has further concentrated wastes stored in the tanks by evaporation to make room for adding more liquids and they have added significant amounts of sodium hydroxide and sodium nitrite to the tanks to maintain high pH and chemically reducing conditions that inhibit tank corrosion. These practices have led to highly concentrated chemical solutions and the precipitation of sodium nitrate/nitrite salts. When the high-level waste tanks are emptied the salt cake will have to be re-dissolved by purified water thus leading to the creation of millions of gallons of additional liquid waste requiring future treatment.

Currently, both the Savannah River Site (SRS) and Hanford Site (Hanford) have experienced delays associated with the design, installation and commissioning of equipment needed to separate strontium-90 (Sr-90) and cesium-137 (Cs-137) from the high-level waste supernate and related liquids. The inability to effectively remove Sr-90 and Cs-137 could cause the sites to miss regulatory milestones and extend the time required for the site cleanup missions thus resulting in hundreds of millions of dollars of cost overruns.

Therefore there at least remains a need in the art for methods and systems for treating liquid wastes having high levels of radionuclides such as cesium and strontium.

### SUMMARY

Example embodiments of the present invention recognize and address considerations of prior art constructions and methods.

According to one aspect, an example embodiment of the present invention provides a method for treating a liquid waste having at least one radionuclide in a salt solution. The method includes supplying the liquid waste to a plurality of cross flow filters from at least one high level waste tank; filtering the liquid waste via the plurality of cross flow filters to form a clarified salt solution; removing at least one radionuclide from the clarified salt solution via a plurality of elutable ion exchange columns filled with an ion exchange media to form an eluate and a decontaminated salt solution; and removing at least one radionuclide from the eluate via a first non-elutable adsorption component to form a dewatered radionuclide sorbent and a decontaminated eluate solution.

According to another aspect, an example embodiment of the present invention provides a regenerable system for treating a liquid waste having at least one radionuclide in a salt solution. The system includes a plurality of cross flow filters having an inlet and an outlet, a plurality of elutable ion exchange columns in fluid communication with the outlet and comprising an eluate outlet and a decontaminated salt solution outlet, and a first non-elutable adsorption component in fluid communication with the eluate outlet and comprising a decontaminated eluate solution outlet. The plurality of elutable ion exchange columns comprises an ion exchange media.

Those skilled in the art will appreciate the scope of the present invention and realize additional aspects thereof after reading the following detailed description of example embodiments in association with the accompanying drawing figures.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a flow diagram of a regenerable system in accordance with an example embodiment of the present invention;

FIG. 2 is a process flow diagram of a method in accordance with an example embodiment of the invention;

FIG. 3 is a process flow diagram of a method in accordance with an example embodiment of the invention;

FIG. 4 is a process flow diagram of a method in accordance with an example embodiment of the invention;

FIG. 5 is a process flow diagram of a method in accordance with an example embodiment of the invention; and

FIG. 6 is a flow diagram of a plurality of ion exchange columns in accordance with an example embodiment of the present invention.

Repeat use of reference characters in the present specification and drawings is intended to represent same or analogous features or elements of the invention.

### DETAILED DESCRIPTION

Reference will now be made in detail to certain preferred embodiments of the present invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations.

Exemplary embodiments provide a regenerable system and method that can be designed, manufactured, installed, and commissioned in a short timeframe to address waste treatment and disposal issues, which, for example, would aid the DOE in meeting regulatory commitments and budgetary constraints. Of particular value is the ability to send cesium loaded non-elutable adsorption media directly to disposal, thus eliminating the need, for example, for producing “salt-only” waste canisters at SRS and for operating the High Level Waste (HLW) vitrification facility for supernate treatment at Hanford.

In one aspect, a regenerable system for treating a liquid waste having at least one radionuclide in a salt solution is provided. In general, the system may include a plurality of cross flow filters (e.g., four) having an inlet and an outlet, a plurality of elutable ion exchange columns in fluid communication with the outlet and comprising an eluate outlet and a decontaminated salt solution outlet, and a first non-elutable adsorption component in fluid communication with the eluate outlet and comprising a decontaminated eluate solution outlet. In some embodiments, the plurality of elutable ion exchange columns may comprise an ion exchange media.

In accordance with an exemplary embodiment, the liquid waste may comprise at least one radionuclide. In some embodiments, for instance, the liquid waste may comprise at least one of cesium, strontium, actinide, or any combination thereof. In further embodiments, for example, the liquid waste may comprise cesium.

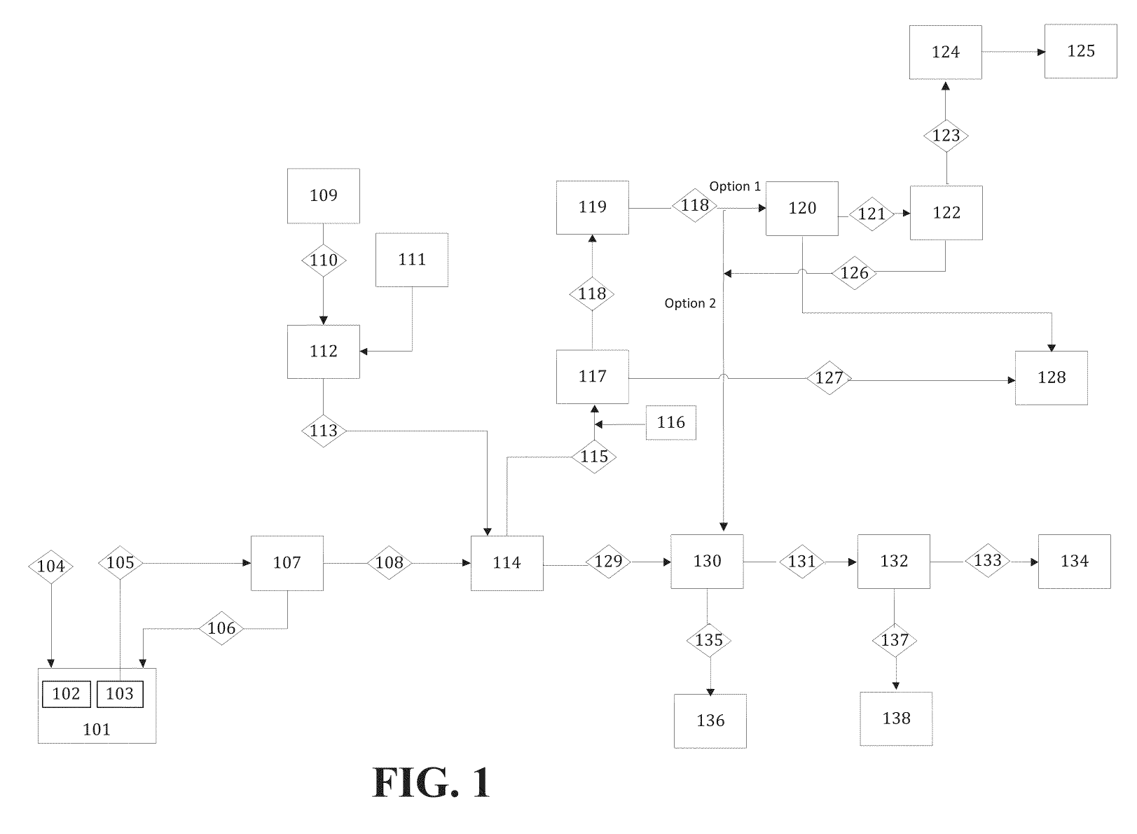

FIG. 1, for example, illustrates a regenerable system in accordance with an example embodiment. As shown in FIG. 1, for instance, the regenerable system may include at least one high level waste tank 101. In accordance with an exemplary embodiment and as shown in FIG. 1, for instance, the at least one high level waste tank 101 may comprise a mixer 102 and a pump 103. In this regard, by utilizing the mixer 102 and the pump 103, the at least one high level waste tank 101 may be configured to supply liquid waste in the form of a liquid supernate 105 to the plurality of cross flow filters 107. In some embodiments, for example, the plurality of cross flow filters 107 may include standard cross flow filters, rotary microfilters and/or the like. According to certain embodiments, for instance, the plurality of cross flow filters 107 may be arranged in series or in parallel. Moreover, although multiple cross flow filters 107 are referenced herein, the system may comprise only one cross flow filter 107. In addition, although cross flow filters are referenced herein, any filtration means suitable for use with the regenerable system as understood by one of ordinary skill in the art may be used.

The plurality of cross flow filters 107, for instance, may separate the liquid supernate 105 into a clarified salt solution 108 and a filter reject 106 (e.g. undissolved solids, adsorbent, etc.). The filter reject 106 may then be returned to the at least one high level waste tank 101 for future vitrification treatment. Prior to filtration by the plurality of cross flow filters 107, in some embodiments, for example, the liquid waste contained in the at least one high level waste tank 101 may be treated with at least one targeted radionuclide adsorbent (e.g., a strontium adsorbent, an actinide adsorbent and/or the like).

Following filtration by the plurality of cross flow filters 107, for instance, the clarified salt solution 108 may move through a plurality of elutable ion exchange columns 114 (e.g., Generation 3 Shielded Ion Exchange Module (SIXM3)). In some embodiments, for example, the plurality of elutable ion exchange columns may comprise a gamma dose rate reduction by a factor greater than 10⁶. In further embodiments, for instance, the plurality of elutable ion exchange columns may comprise a maximum decay heat loading of about 3,000 W (e.g., 2,896 W). Although multiple elutable ion exchange columns 114 are referenced herein, the system may comprise only one elutable ion exchange column 114.

The plurality of elutable ion exchange columns 114 may include at least one ion exchange media. According to certain exemplary embodiments, for instance, the ion exchange media may comprise spherical resorcinol formaldehyde (sRF). In such embodiments, for example, the sRF may be used for over thirty loading/elution/regeneration cycles. In further embodiments, for instance, the sRF may comprise a loading cycle of about 155 bed volumes. In addition, by using sRF as the ion exchange media, for instance, the plurality of elutable ion exchange columns 114 may achieve high cesium decontamination factors (e.g., 5,000²) in liquid waste. Moreover, in certain embodiments, for example, eluted cesium may be adsorbed onto another sorbent ore returned to a tank as secondary liquid waste.

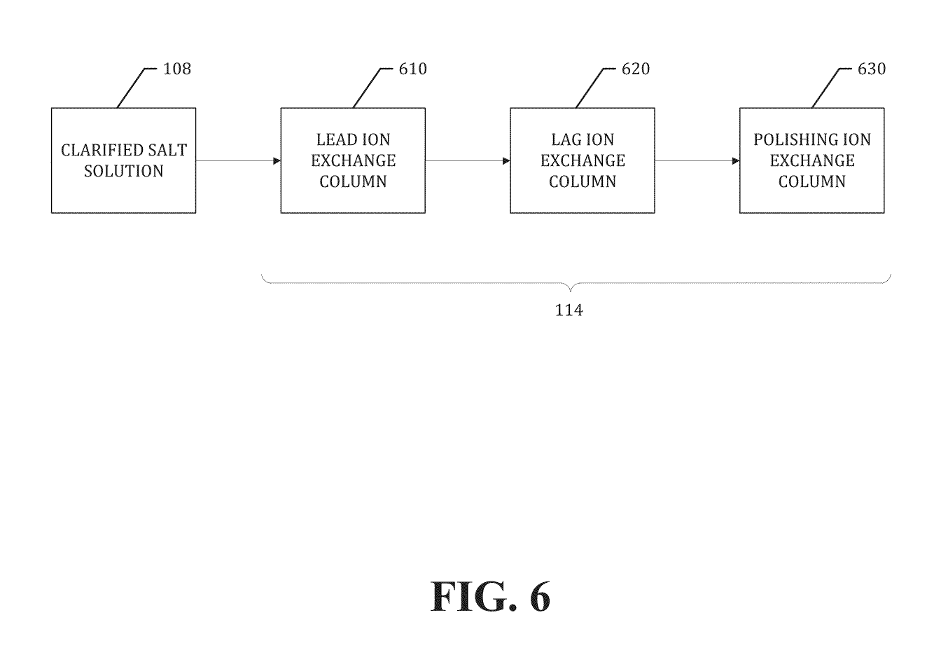

Moreover, in accordance with certain embodiments and as shown in FIG. 6, for instance, the plurality of elutable ion exchange columns 114 may comprise a lead ion exchange column 610, a lag ion exchange column 620, and a polishing ion exchange column 630. In some embodiments, for instance, the lead ion exchange column 610, the lag ion exchange column 620, and the polishing ion exchange column 630 may be arranged in series. In other embodiments, for example, the plurality of elutable ion exchange columns 114 may be positioned on an ion exchange column carousel. In this regard, the plurality of elutable ion exchange columns 114 may be stationary or rotatable. In certain embodiments, for example, the plurality of elutable ion exchange columns 114 may include only a lead ion exchange column 610 and a lag ion exchange column 620. Regardless of the arrangement of the lead ion exchange column 610, the lag ion exchange column 620, and the polishing ion exchange column 630, the clarified salt solution 108 may travel through the plurality of elutable ion exchange columns 114 through the lead-lag-polishing configuration for cesium removal. In this regard, for instance, the clarified salt solution 108 may be decontaminated to form a decontaminated salt solution 129 and eluate solutions 115. In embodiments in which the eluate solutions 115 result from sRF elution/regeneration, the eluate solutions 115 may comprise nitric acid. In such embodiments, for example, the eluate solutions 115 may comprise nitric acid at a concentration of about 0.2M.

According to certain embodiments, for example, the decontaminated salt solution 129 may then be transferred to a waste processor 130. In some embodiments, for instance, the waste processor 130 may be in fluid communication with the decontaminated salt solution outlet of the plurality of elutable ion exchange columns 114. In this regard, the waste processor 130 may package, stabilize, and/or treat the decontaminated salt solution 129. In certain embodiments, for example, the waste processor 130 may scrub the decontaminated salt solution 129. In some embodiments, for instance, the waste processor 130 may comprise a processing facility (e.g., Saltstone Processing Facility (SPF) at SRS), a direct feed low activity vitrifier (e.g., DFLAW at Hanford), a supplemental low activity vitrifier (e.g., supplemental LAW at Hanford) and/or the like. Moreover, in further embodiments, for example, the decontaminated salt solution 129 may be transferred to tanker trucks for off-site processing. As a result of processing by the waste processor 130, packaged solids 135 (e.g., cement-like grout, stabilized glassified waste canisters, filters, resins, solidified concentrations and/or the like) and a scrubber condensate 131 may be formed. In some embodiments, for instance, the packaged solids 135 may be disposed via any suitable means of solid waste disposal 136 understood by one of ordinary skill in the art. In further embodiments, for example, the scrubber condensate 131 may undergo condensate treatment. For instance, the scrubber condensate 131 may be treated by any suitable effluent treatment means 132 understood by one of ordinary skill in the art. Treatment by the effluent treatment means 132 may form purified water 137 and packaged solids 133 (e.g., cesium-loaded non-elutable adsorbent columns, cement-like grout, stabilized glassified waste canisters, filters, resins, solidified concentrations and/or the like). The purified water 137 may be disposed of by any suitable water disposal means 138 understood by one of ordinary skill in the art. Moreover, the packaged solids 133 may be disposed via any suitable means of solid waste disposal 134 understood by one of ordinary skill in the art.

In accordance with certain embodiments, for example, the eluate solutions 115 formed from the treatment of the clarified salt solution 108 with the plurality of elutable ion exchange columns 114 or from sRF elution/regeneration may be treated with an alkali 116 and run through a first non-elutable adsorption component 117 to form a decontaminated eluate solution 118, which may be stored in one or more eluate tanks 119. In this regard, the first non-elutable adsorption may remove cesium from all eluate and eluate related liquids (rinses, etc.) upstream of the eluate tanks 119. The first (and similarly the second) non-elutable adsorption components 117, 120 may be physically located inside at least one shielded transport cask wherein several operations involving liquid treatment and waste processing may take place prior to transporting the non-elutable adsorption components 117, 120. The non-elutable adsorption components 117, 120 may be designed with remote ancillary features that allow them to be loaded with cesium, dewatered, and sealed for shipment in a safe and ALARA manner. The non-elutable adsorption components 117, 120 may be operated in a manner that precludes the accumulation of cesium and related liquid waste radionuclides above legal cutoff limits, which makes the dewatered non-elutable adsorption components 117, 120 candidates for disposal as low-level waste (LLW). In particular, after treatment by non-elutable adsorption components 117, 120, the cesium concentration in the decontaminated eluate solutions 118, 121 may be very low, and the neutralized sodium nitrate in this stream may be at a concentration of about 0.25 M. In this regard, the decontaminated eluate solutions 118, 121 may have low concentrations of radionuclides and salts.

In some embodiments, for instance, the one or more eluate tanks 119 may be in fluid communication with the decontaminated eluate solution outlet of the first non-elutable adsorption component 117. Moreover, in further embodiments, for example, the one or more eluate tanks 119 may comprise an eluate tank outlet. According to certain exemplary embodiments, for instance, the first non-elutable adsorption component 117 may comprise a plurality of non-elutable adsorption columns (e.g., 3 Generation 2 Shielded Ion Exchange Modules (SIXM2)). The plurality of non-elutable adsorption columns may be arranged in series, on a carousel and/or the like. In some embodiments, for example, the first non-elutable adsorption component 117 may comprise at least one of chabazite zeolite, crystalline silicotitanate (CST), metal-hexacyanoferrate (FeCN), or any combination thereof. In further embodiments, for instance, the first non-elutable adsorption component 117 may comprise chabazite zeolite. The zeolite may provide effective removal of cesium from the eluate solution 115 comprising dilute sodium nitrate.

In accordance with an exemplary embodiment, the decontaminated eluate solution 118 may either flow through a second non-elutable adsorption component 120 to form a double decontaminated eluate solution 121, or, in other embodiments, may flow directly to the waste processor 130 to be processed if the decontaminated eluate solution 118 comprises a low cesium concentration. In some embodiments, for example, the second non-elutable adsorption component 120 may be in fluid communication with the eluate tank outlet. Moreover, in further embodiments, for instance, the second non-elutable adsorption component 120 may comprise a second non-elutable adsorption component outlet. According to certain exemplary embodiments, for instance, the second non-elutable adsorption component 120 may also comprise a plurality of non-elutable adsorption columns (e.g., 3 Generation 2 Shielded Ion Exchange Modules (SIXM2)). The plurality of non-elutable adsorption columns may be arranged in series, on a carousel and/or the like. In some embodiments, for example, the second non-elutable adsorption component 120 may comprise at least one of chabazite zeolite, crystalline silicotitanate (CST), metal-hexacyanoferrate (FeCN), or any combination thereof. In further embodiments, for instance, the second non-elutable adsorption component 120 may comprise chabazite zeolite.

If the decontaminated eluate solution 118 flows through the second non-elutable adsorption component 120 to form the double decontaminated eluate solution 121, for example, the double decontaminated eluate solution 121 may then flow through a concentrator 122 (e.g., sodium nitrate concentrator) to form purified water 123 and concentrator reject 126. In some embodiments, for example, the concentrator 122 may be in fluid communication with the second non-elutable adsorption component outlet. In certain embodiments, for example, the concentrator 122 may comprise any suitable means of reverse osmosis, evaporation and/or the like as understood by one of ordinary skill in the art. Moreover, in further embodiments, for instance, the concentrator 122 may comprise a purified water outlet and a concentrator reject outlet. In certain embodiments, for example, the concentrator reject outlet may be in fluid communication with the waste processor 130. The purified water may be stored in one or more purified water storage tanks 124, which may be in fluid communication with the purified water outlet, and, in this regard, provide reclaimed water for reuse 125. The concentrator reject 126, however, may then flow to the waste processor 130 to be processed as previously described herein.

In accordance with certain embodiments, for example, sodium hydroxide may be added to the decontaminated eluate solution 118 and/or the double decontaminated eluate solution 121, and the treated decontaminated eluate solutions 118, 121 may be transferred to a holding tank or to one or more of the high level waste tanks 101. In such embodiments, for instance, the decontaminated eluate solutions 118, 121 may be an 0.2M solution of sodium nitrate having a pH greater than 12 or any other suitable alkaline pH value. In this regard, the treated decontaminated eluate solutions 118, 121 may be reused in salt dissolution.

The system described above may be used until the lead ion exchange column 610 requires regeneration. The method of regenerating the lead ion exchange column 610 is discussed in more detail below. However, to accomplish regeneration, one or more reagents 110 (e.g., sodium hydroxide, sodium nitrate and/or the like) may be stored in one or more reagent tanks 109. The reagents 110 and reclaimed water 111 may flow to one or more eluent tanks 112 to form eluent solutions 113. The eluent solutions 113 may then be utilized in the regeneration of the lead ion exchange column 610. In this regard, the elution/regeneration cycle may be counter-current from oldest to the most recently eluted ion exchange column such that freshly eluted and regenerated ion exchange columns 114 will be placed on-line in the polishing position 630 and then sequenced forward as upstream columns 610, 620 experience cesium breakthrough.

In accordance with certain embodiments, for example, the system may operate at a treatment rate from about 1 gallon/min. to about 100 gallons/min. In other embodiments, for instance, the system may operate at a treatment rate from about 3 gallons/min. to about 50 gallons/min. In further embodiments, for example, the system may operate at a treatment rate from about 5 gallons/min. to about 25 gallons/min. In some embodiments, for instance, the system may operate at a treatment rate from about 7 gallons/min. to about 12 gallons/min. In certain embodiments, for example, the system may operate at a treatment rate of about 10 gallons/min. As such, in certain embodiments, the system may operate at a treatment rate from at least about any of the following: 1, 2, 3, 4, 5, 6, 7, 8, 9, and 10 gallons/min. and/or at most about 100, 75, 50, 40, 30, 25, 20, 15, 12, 11, and 10 gallons/min. (e.g., about 8-75 gallons/min, about 10-100 gallons/min., etc.).

In accordance with certain embodiments, for instance, the system may operate at a temperature from about 10° C. to about 60° C. In other embodiments, for example, the system may operate at a temperature from about 20° C. to about 50° C. In further embodiments, for instance, the system may operate at a temperature from about 30° C. to about 40° C. In certain embodiments, for example, the system may operate at a temperature of about 38° C. As such, in certain embodiments, the system may operate at a temperate from at least about any of the following: 10, 15, 20, 25, 30, 35, and 38° C. and/or at most about 60, 55, 50, 45, 40, and 38° C. (e.g., about 30-50° C., about 20-60° C., etc.).

In another aspect, a method for treating a liquid waste having at least one radionuclide in a salt solution is provided. In general, the method may include supplying the liquid waste to a plurality of cross flow filters from at least one high level waste tank; filtering the liquid waste via the plurality of cross flow filters to form a clarified salt solution; removing at least one radionuclide from the clarified salt solution via a plurality of elutable ion exchange columns filled with an ion exchange media to form an eluate and a decontaminated salt solution; and removing at least one radionuclide from the eluate via a first non-elutable adsorption component to form a dewatered radionuclide sorbent and a decontaminated eluate solution. Moreover, any and all disclosures made in relation to the system also apply to the method as described herein.

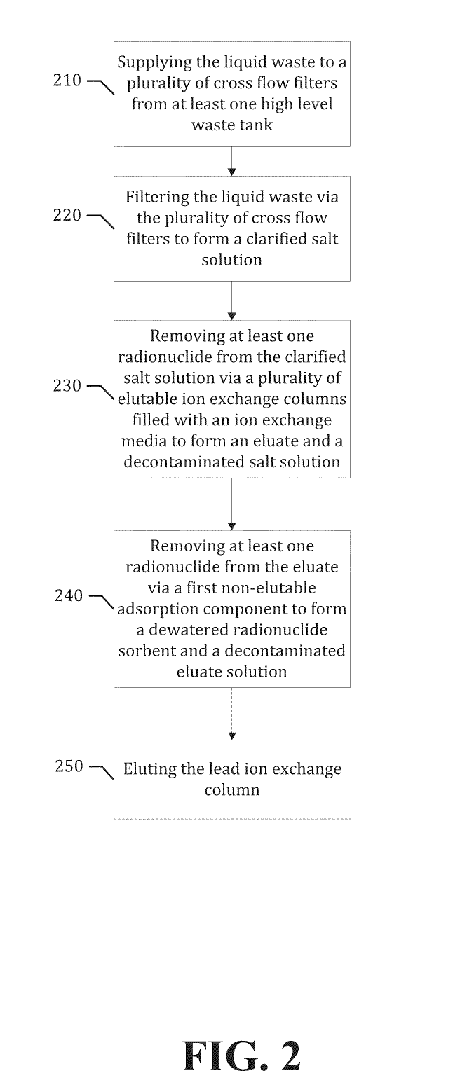

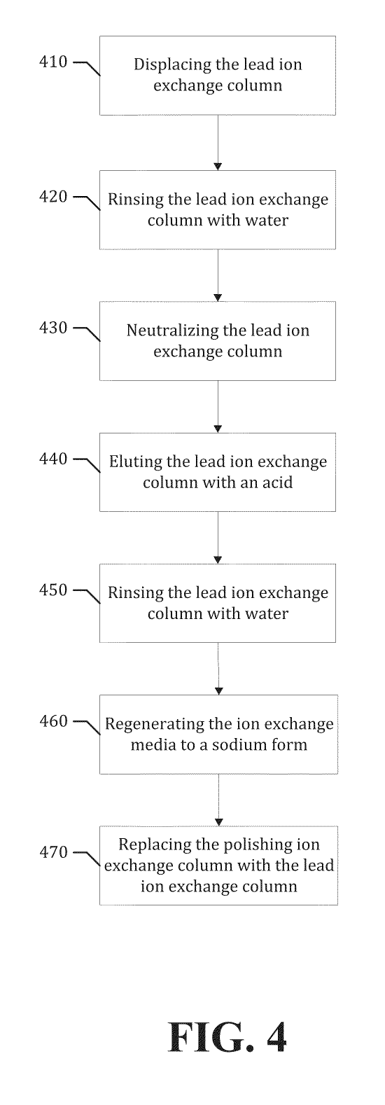

FIGS. 2-5, for example, illustrate the method in accordance with example embodiments. As shown in FIG. 2, for instance, the method may comprise supplying the liquid waste to a plurality of cross flow filters from at least one high level waste tank at operation 210; filtering the liquid waste via the plurality of cross flow filters to form a clarified salt solution at operation 220; removing at least one radionuclide from the clarified salt solution via a plurality of elutable ion exchange columns filled with an ion exchange media to form an eluate and a decontaminated salt solution at operation 230; and removing at least one radionuclide from the eluate via a first non-elutable adsorption component to form a dewatered radionuclide sorbent and a decontaminated eluate solution at operation 240. The method may also include an optional step of eluting the lead ion exchange column at operation 250, which is described in greater detail in relation to FIG. 4 herein.

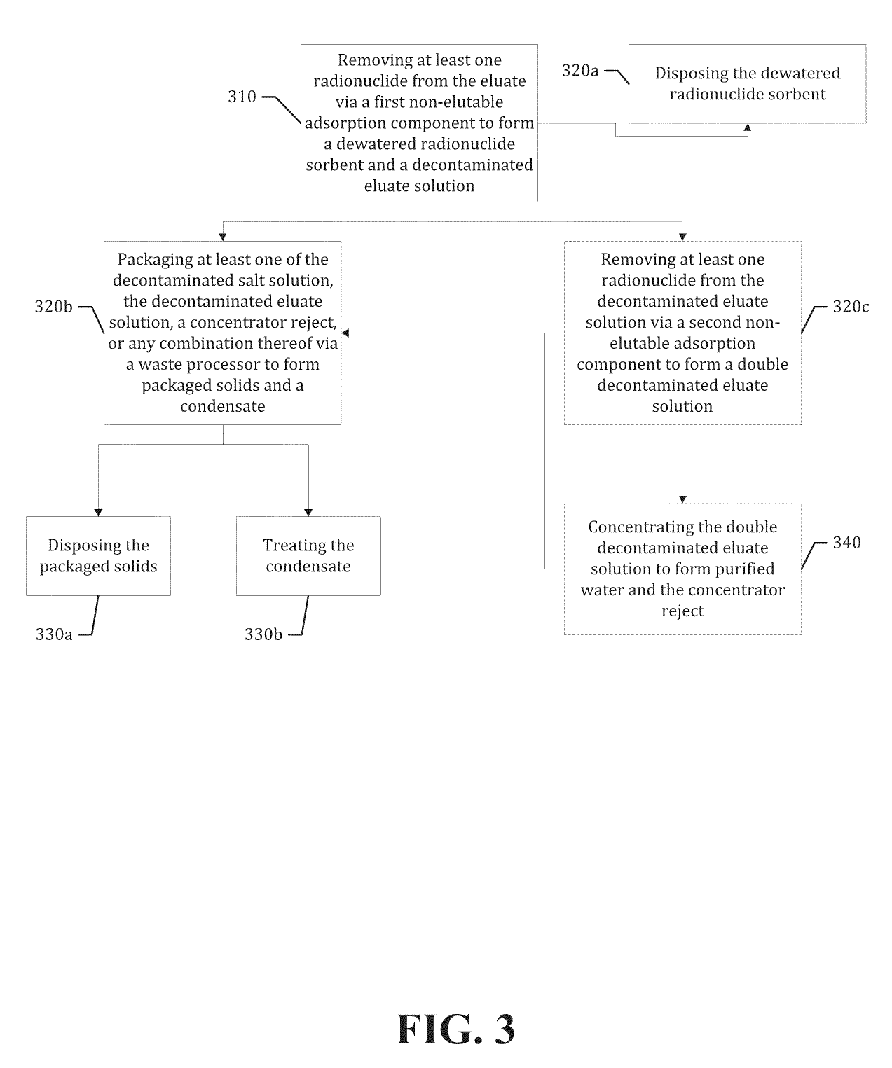

As shown in FIG. 3, for example, removing at least one radionuclide from the eluate via a first non-elutable adsorption component to form a dewatered radionuclide sorbent and a decontaminated eluate solution at operation 310 may be followed by one or more of disposing the dewatered radionuclide sorbent at operation 320a, packaging at least one of the decontaminated salt solution, the decontaminated eluate solution, a concentrator reject, or any combination thereof via a waste processor to form packaged solids and a condensate at operation 320b, and/or removing at least one radionuclide from the decontaminated eluate solution via a second non-elutable adsorption component to form a double decontaminated eluate solution at operation 320c. As further shown by FIG. 3, operation 320b may be followed by disposing the packaged solids at operation 330a and/or treating the condensate at operation 330b. Moreover, if operation 320c is used, then operation 320c may be followed by concentrating the double decontaminated eluate solution to form purified water and the concentrator reject at operation 340. Following operation 340, the method may start at operation 320b and proceed through at least one of operations 330a and 330b.

As shown in FIG. 4, for example, eluting the lead ion exchange column may comprise displacing the lead ion exchange column at operation 410, rinsing the lead ion exchange column with water at operation 420, neutralizing the lead ion exchange column, eluting the lead ion exchange column with an acid (e.g., nitric acid) at operation 430, rinsing the lead ion exchange column with water at operation 440, regenerating the ion exchange media to a sodium form via, e.g., sodium hydroxide, at operation 450, and replacing the polishing ion exchange column with the lead ion exchange column at operation 460.

In this regard, in certain embodiments, for example, the elution/regeneration method may last from about 12 hours to about 48 hours. In other embodiments, for instance, the elution/regeneration method may last from about 18 hours to about 40 hours. In further embodiments, for example, the elution/regeneration method may last from about 20 hours to about 30 hours. In certain embodiments, for instance, the elution/regeneration method may last about 24 hours. As such, in certain embodiments, the elution/regeneration method may last for a time from at least about any of the following: 12, 15, 18, 20, 21, 22, 23, and 24 hours and/or at most about 48, 45, 40, 35, 30, 29, 28, 27, 26, 25, and 24 hours (e.g., about 18-26 hours, about 21-30 hours, etc.).

Moreover, according to certain embodiments, for example, the sRF may go through an elution/regeneration cycle after treating from about 25,000 gallons to about 75,000 gallons. In other embodiments, for instance, the sRF may go through an elution/regeneration cycle after treating from about 40,000 gallons to about 60,000 gallons. In further embodiments, for example, the sRF may go through an elution/regeneration cycle after treating about 50,000 gallons. As such, in certain embodiments, the sRF may go through an elution/regeneration cycle after treating a number of gallons of liquid waste from at least about any of the following: 25,000; 30,000; 35,000; 40,000; 45,000; and 50,000 gallons and/or at most about 75,000; 70,000; 65,000; 60,000; 55,000; and 50,000 gallons (e.g., about 40,000-65,000 gallons, about 50,000-75,000 gallons, etc.). In this regard, each elution/regeneration cycle may generate about 6,200 gallons of cesium-laden eluate and regeneration chemicals (i.e. eluent solutions 113) to be transferred to the one or more eluate tanks 119.

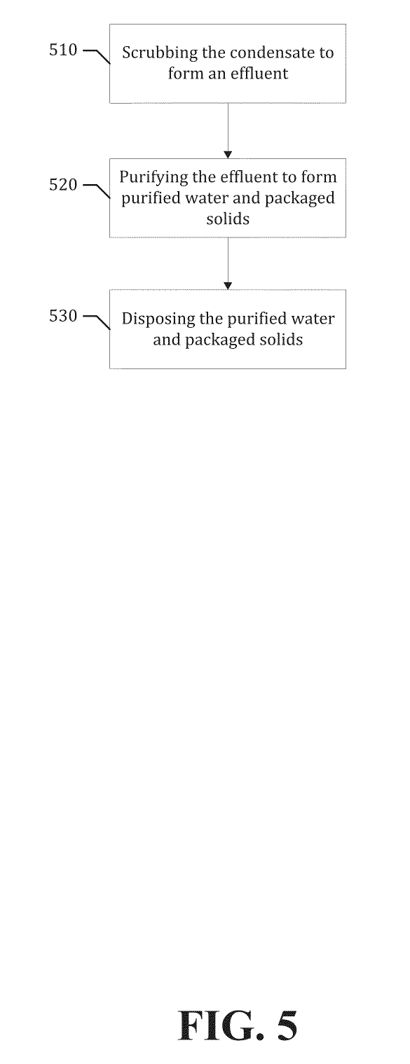

As shown in FIG. 5, for example, treating the condensate may comprise scrubbing the condensate to form an effluent at operation 510, purifying the effluent to form purified water and packaged solids at operation 520, and disposing the purified water and the packaged solids at operation 530.

While one or more example embodiments of the invention have been described above, it should be understood that any and all equivalent realizations of the present invention are included within the scope and spirit thereof. In addition, the embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

1. A method for treating a liquid waste having at least one radionuclide in a salt solution, comprising:
supplying the liquid waste to a plurality of cross flow filters from at least one high level waste tank;
filtering the liquid waste via the plurality of cross flow filters to form a clarified salt solution;
removing at least one radionuclide from the clarified salt solution via a plurality of elutable ion exchange columns filled with an ion exchange media to form an eluate and a decontaminated salt solution; and
removing at least one radionuclide from the eluate via a first non-elutable adsorption component to form a dewatered radionuclide sorbent and a decontaminated eluate solution.

2. The method of claim 1, further comprising disposing the dewatered radionuclide sorbent.

3. The method of claim 1, wherein the plurality of elutable ion exchange columns comprise a lead ion exchange column, a lag ion exchange column, and a polishing ion exchange column.

4. The method of claim 3, further comprising eluting the lead ion exchange column, wherein eluting the lead ion exchange column comprises displacing the lead ion exchange column, rinsing the lead ion exchange column with water, neutralizing the lead ion exchange column, eluting the lead ion exchange column with an acid, rinsing the lead ion exchange column with water, regenerating the ion exchange media to a sodium form, and replacing the polishing ion exchange column with the lead ion exchange column.

5. The method of claim 1, wherein the ion exchange media comprises spherical resorcinol formaldehyde (sRF).

6. The method of claim 1, further comprising:
packaging at least one of the decontaminated salt solution, the decontaminated eluate solution, a concentrator reject, or any combination thereof via a waste processor to form packaged solids and a condensate;
disposing the packaged solids; and
treating the condensate.

7. The method of claim 6, wherein treating the condensate comprises:
scrubbing the condensate to form an effluent;
purifying the effluent to form purified water and packaged solids; and
disposing the purified water and the packaged solids.

8. The method of claim 6, further comprising:
removing at least one radionuclide from the decontaminated eluate solution via a second non-elutable adsorption component to form a double decontaminated eluate solution; and
concentrating the double decontaminated eluate solution to form purified water and the concentrator reject.

9. The method of claim 8, wherein each of the first non-elutable adsorption component and the second non-elutable adsorption component comprise a plurality of non-elutable adsorption columns.

10. The method of claim 8, wherein each of the first non-elutable adsorption component and the second non-elutable adsorption component comprise at least one of chabazite zeolite, crystalline silicotitanate (CST), metal-hexacyanoferrate (FeCN), or any combination thereof.

11. The method of claim 1, wherein the at least one high level waste tank comprises a mixer and a pump.

12. The method of claim 1, wherein the at least one radionuclide comprises cesium.

13. A regenerable system of treating a liquid waste having at least one radionuclide in a salt solution, comprising:
a plurality of cross flow filters having an inlet and an outlet;
a plurality of elutable ion exchange columns in fluid communication with the outlet, said plurality of elutable ion exchange columns comprising an eluate outlet and a decontaminated salt solution outlet; and
a first non-elutable adsorption component in fluid communication with the eluate outlet, said first non-elutable adsorption component comprising a decontaminated eluate solution outlet,
wherein the plurality of elutable ion exchange columns comprise an ion exchange media.

14. The system of claim 13, wherein the ion exchange media comprises spherical resorcinol formaldehyde (sRF).

15. The system of claim 13, wherein the plurality of non-elutable adsorption columns comprise at least one of chabazite zeolite, crystalline silicotitanate (CST), metal-hexacyanoferrate (FeCN), or any combination thereof.

16. The system of claim 13, further comprising:
at least one high level waste tank configured to supply liquid waste to the plurality of cross flow filters;
an eluate tank in fluid communication with the decontaminated eluate solution outlet, said eluate tank comprising an eluate tank outlet; and
a waste processor in fluid communication with the decontaminated salt solution outlet.

17. The system of claim 16, further comprising:
a second non-elutable adsorption component in fluid communication with the eluate tank outlet, said second non-elutable adsorption component comprising a second non-elutable adsorption component outlet;
a concentrator in fluid communication with the second non-elutable adsorption component outlet, said concentrator comprising a purified water outlet and a concentrator reject outlet, the concentrator reject outlet being in fluid communication with the waste processor; and
at least one purified water storage tank in fluid communication with the purified water outlet,
wherein each of the first non-elutable adsorption component and the second non-elutable adsorption component comprises a plurality of non-elutable adsorption columns.

18. The system of claim 16, wherein the at least one high level waste tank comprises a mixer and a pump.

19. The system of claim 13, wherein the liquid waste comprises at least one radionuclide.

20. The system of claim 19, wherein the at least one radionuclide comprises cesium.
